(19) United States
(12) Patent Application Publication
(10) Pub. No.: US 2021/0145207 A1
(43) Pub. Date: May 20, 2021

(54) DEVICE FOR CONTAINING AND PRESERVING BEVERAGES AND MACHINE FOR PREPARING BEVERAGES COMPRISING SUCH DEVICE

(71) Applicant: CMA MACCHINE PER CAFFE' S.R.L., Susegana TV (IT)

(72) Inventors: Beppino CEOTTO, Susegana TV (IT); Andrea ZONELLI, Susegana TV (IT)

(21) Appl. No.: 17/056,858

(22) PCT Filed: May 22, 2019
(86) PCT No.: PCT/IB2019/054231

§ 371 Date: Nov. 19, 2020

(30) Foreign Application Priority Data
May 23, 2018 (IT) 102018000005646

(51) Int. Cl. A47J 31/46; A23F 5/26; A47J 31/52

(52) U.S. Cl. CPC A47J 31/467; A47J 31/461; A47J 2203/00; A47J 31/5253; A23F 5/262

(57) ABSTRACT

A device (5) for containing and preserving beverages, comprising at least one storage chamber (5a) for at least one beverage is described, said storage chamber (5a) being provided with at least one inlet (5b) for the injection of the beverage and with at least one outlet (5c), wherein the outlet (5c) is fluidically connected to a delivering assembly (6) for the delivery of the beverage. The device (5) comprises at least one fluid source (9) fluidically connected with said at least one storage chamber (5a) for the adduction of a fluid flow into said storage chamber (5a) to stir said beverage. A machine (1) for preparing a beverage, preferably by means of percolation, comprising such device (5), and the relative methods of use are also described.

### FIELD OF THE INVENTION

The present invention concerns a device for containing beverages, adapted for preserving and maintaining thereof, and combinable with machines for preparing beverages. The present invention further concerns a machine for preparing a beverage, and especially coffee, preferably by percolation. The present invention further concerns the relative methods of use of the beverage containing device and the machine.

In particular, the present invention concerns a device for containing and preserving beverages, such device is combinable with a machine for preparing beverages, preferably a percolation machine.

The present invention further concerns a machine for preparing a beverage, especially coffee, for private and professional use (such as for example in restaurants, bars, hotels), etc. Preferably, the machine for preparing the beverage, and especially coffee, is a percolation machine.

### KNOWN PRIOR ART

It should immediately be noted that the expression “beverage containing device” here and hereinafter means a device adapted to contain and preserve beverages at their optimal state, before being delivered. Such device can be combined with a machine for preparing beverages, preferably a percolation machine, and in such a case, the beverage obtained (for example by percolation) is collected, before being delivered, in such a device where it is maintained until the user delivers it, for example in a cup, glass or other container. The beverage containing device can also be independent of the machine and the beverage can be injected in such a device by other means, for example manually by the user.

Devices for containing and maintaining beverages before being delivered are known in the art. Such devices are for example used in the hotel sector, and in restaurants in general.

The beverage contained therein, has components such as oils and aromas, extracted from ingredients (preferably powdered) present in different concentrations, as a product of the beverage preparation steps.

The beverage can remain inside the storage chamber for different periods of time, even extended, depending on the needs of the user to deliver the beverage contained therein.

For this reason, due to the stratification and sedimentation process, the components present in the beverage can separate, thus creating layers with different beverage components and such components can possibly accumulate on the bottom and/or on the walls of the storage chamber, altering the taste of the beverage.

The aroma of the latter will, for example, be impoverished or enriched depending on when the delivery will be carried out.

Such drawbacks are also reported in machines for preparing beverages (for example in percolation machines), and, in general, when the containing device is combined with a machine for preparing beverages, for example a percolation machine. It should be noted that the expression “percolation machine” is here and hereinafter used to denote a machine that allows to prepare a beverage, and especially coffee, by water passing, preferably warm, through at least one ingredient, and especially coffee, which is contained inside a percolation chamber preferably provided with a filter. Such machines are also known in the art under the term “filter machine” or “drip coffee machines”. The beverage obtained from coffee powder as a preparation ingredient is usually called brewed coffee, or filtered coffee, or American coffee.

Percolation machines for preparing and delivering beverages are known in the art. The preparation of beverages by percolation provides for the passage of a liquid through a porous body, i.e. a process thanks to which the preparation water, by passing through the ingredient, preferably powdered, such as for example coffee powder, extracts its aromas and oils. Preferably, the water passes through the powder ingredient by gravity.

Generally, a percolation machine is provided with a water source connected to a boiler, or similar heating devices.

Here, the water is heated to a predetermined temperature, which is usually lower than the boiling one, and successively channeled towards a percolation chamber. At least one ingredient for the preparation of the beverage, for example ground coffee, is positioned inside the percolation chamber, which is provided with filtering means which can either be integrated inside the chamber or removable.

The ingredient placed inside the percolation chamber is the porous means through which the beverage preparation water flows before being collected inside the storage chamber.

The beverage obtained and collected has components in different concentrations, such as oils and aromas extracted from the ingredient, as the product of the percolation step.

In the state of the art, machines which have, on the bottom of the storage chamber, stirrers of the mechanical type are known.

However, in addition to being complex and costly to make, such solution is little effective in solving the drawbacks discussed above relative to the stratification and sedimentation of the components present in the beverage, which, as mentioned, can accumulate on the bottom and/or the walls of the storage chamber, altering the taste of the beverage.

A different type of known devices concerns the so-named adders of carbon dioxide in refrigerated water containers. Such devices are for example known in the documents US2013309361 and US2016256837.

However, it should first be noted that the addition of carbon dioxide cannot be used to solve the drawbacks relative to the stratification and sedimentation of the components present in the beverage, which, as mentioned, can accumulate on the bottom and/or the walls of the storage chamber. In fact, the addition of carbon dioxide would not have effects on possible layers or residues, or on the separation of the components of the beverage, and especially of the coffee.

Moreover, the addition of carbon dioxide considerably alters the beverage, thus making such devices known in the art limited to a specific field or sector which does not find application with beverages in which the organoleptic and taste characteristics must be preserved, especially like coffee.

An object of the present invention is to provide a device for containing and preserving beverages and a method of use thereof, which allows to stir the beverage preserved inside it in an effective way that is also economic to make and simple to control.

An object of the present invention is further to provide a machine and a method for preparing a beverage, preferably by percolation, able to maintain, or increase, the final quality of the beverage, also for long periods of permanence inside the storage chamber.

Object of the present invention is to increase the efficiency of the beverage preparation process, for example by percolation, and to solve the drawback relative to the stratification/sedimentation of the components of the beverage obtained, which occurs following the permanence of the prepared beverage inside the storage chamber for medium to long periods of time. Object of the present invention is also to allow the stirring of the beverage inside the chamber in an effective way, that is also economic to make and simple to control.

### SUMMARY OF THE INVENTION

These and further objectives are achieved by the beverage containing device, by the machine for preparing the beverage and by the method of use according to the respective independent claims. Further characteristics/aspects of the invention are set forth in the dependent claims.

It should also initially be noted that what is described and/or claimed herein, with reference to the containing device, can be applied to the machine for preparing beverages and/or to the method according to the invention, and vice-versa.

The beverage containing device according to the present invention comprises at least one storage chamber, in which at least one beverage is collected, and at least one delivering assembly through which the beverage is delivered to the user.

The device further comprises at least one source of fluid, for example air, put in fluidic connection with the storage chamber, for the adduction of a fluid flow into such chamber to stir the beverage.

Advantageously, the fluid source allows to generate a fluid flow and to channel it towards the beverage inside the storage chamber of the device. This way, the fluid flow allows to stir the beverage in an effective and simple way and without needing to provide mechanical stirring means or members housed inside the storage chamber of the device. In fact, the fluid flow allows to stir the components present in the beverage by acting on possible layers and sediments that form inside the storage chamber.

Moreover, no mechanical stirring means being present, possible contaminations of the beverage due to the materials composing the mechanical stirring members are avoided. According to an aspect of the present invention, the fluid source is a pressurized fluid source.

According to possible aspects of the invention, different fluids (both liquids and gases), preferably edible and, in general, adapted for human consumption, can be used to stir. According to an aspect of the present invention, the fluid used is air. The air can be drawn from the outer environment, from a tank or container, or can also be drawn from the storage chamber of the device, for example above the free surface of the beverage contained therein. A possible advantage of taking air from the storage chamber is that any component of the beverage, in suspension, can possibly be released back in the beverage.

According to an aspect of the present invention, the fluid used is a beverage or liquid, the beverage can be different from the one present inside the storage chamber, or can be the same as the beverage present inside the storage chamber.

According to an aspect of the present invention, the fluid used to stir comprises part of the beverage present inside the storage chamber which is drawn from the storage chamber and released back into the storage chamber. According to an aspect of the present invention, the fluid used to stir is selected so that to maintain the beverage present inside the storage chamber unaltered, and especially coffee. In other words, according to an aspect of the present invention, the fluid flow injected into the storage chamber determines the stirring and thus the removal of possible layers and sediments, but does not alter the beverage contained therein.

Advantageously, the fluid flow injected into the storage chamber of the beverage containing device effectively allows to solve the drawbacks reported in the known machines and containing devices, due to the sedimentation and stratification, allowing to achieve the effective stirring of the beverage.

According to an aspect of the invention, the fluid source adapted to stir the beverage is in fluidic connection with the storage chamber through an opening or a connecting section for the passage of the stirring fluid inside the storage chamber. According to possible embodiments, an opening, for example a hole, can be arranged on one of the walls delimiting the storage chamber. Possible embodiments in which the fluid source to stir the beverage is in fluidic connection with the inlet or the outlet of the storage chamber are not excluded. According to possible embodiments, appropriate fluidic connection means, such as for example a duct, can be used to connect the fluid source with the storage chamber and, in particular, to connect the fluid source with the opening that allows to inject the stirring fluid into the storage chamber.

According to an aspect of the invention, the device further comprises at least one level gauge to measure the level of the beverage contained inside the storage chamber, and according to a possible embodiment, said level gauge is fluidically connected both with the storage chamber and the fluid source.

This way, the stirring fluid flow, preferably pressurized, generated by the source can be injected into the storage chamber, preferably by passing through the level gauge.

More in detail, according to an aspect of the present invention, the beverage level gauge is placed between the at least one fluid source (preferably connected to a side of the level gauge) and the at least one storage chamber, with which it is fluidically connected (preferably connected on the opposite side of the level gauge).

An advantage of such configuration is that the fluid delivered by the fluid source passes through the level gauge to reach the storage chamber. This way, the fluidic connection of the level gauge with the storage chamber is exploited for the passage of the fluid used to stir the beverage.

A further advantage of the passage of the fluid through the level gauge is that, at the beginning of the stirring step, the part of beverage present in the level gauge plus the one present in the duct between the level gauge and the storage chamber are returned inside the storage chamber.

According to an aspect of the present invention, the fluid source is fluidically connected with the lower wall of the storage chamber of at least one containing device, preferably through the level gauge, so that the fluid flow runs from the bottom, so that to make the stirring process more effective.

According to an embodiment, the fluid source is connected to the level gauge by means of a valve interposed between them, preferably the valve is of the three-way type. The presence of a valve, for example of the electrically actuated type, allows to control the connection of the stirring fluid source with the level gauge, and thus with the storage chamber, in a quick and precise way.

According to an aspect of the invention, the level gauge is also connected to the outer environment (outer atmosphere P₀) to advantageously allow a user to read the level of the beverage inside the storage chamber.

According to an aspect of the invention, the level gauge is in fluidic connection with the outer atmosphere (P₀) by means of the valve placed between the fluid source and the level gauge.

Advantageously, according to a possible embodiment, the valve thus alternatively fluidically connects the level gauge with the outer atmosphere and fluid source.

As mentioned, according to an aspect of the present invention, the valve placed between the fluid source and the level gauge is of the three-way type, wherein the first way is fluidically connected with the fluid source, the second way is fluidically connected with the outer atmosphere (P₀) and the third way is fluidically connected with the level gauge.

Such configuration allows to be able to alternatively connect the level gauge with the outer atmosphere (to detect the level inside the storage chamber) and with the fluid source (to stir the beverage contained therein).

According to an aspect of the present invention, the fluidic connection between the level gauge and the outer atmosphere is inhibited during the stirring of the beverage, preferably by closing a way of the valve. This way, there is a fluidic connection between the fluid source, the at least one level gauge and thus the storage chamber of the at least one beverage containing device. Instead, the fluid source is not active and the fluidic connection between the level gauge and the fluid source is inhibited when the stirring is deactivated, preferably by closing a way of the valve.

Advantageously, it is possible to activate the stirring of the coffee at a preferred time or to set it in automatic mode, according to predetermined time intervals.

According to possible embodiments, the stirring of the beverage inside the storage chamber lasts more than 1 second, preferably more than 3 seconds. According to possible embodiments, the stirring cycle lasts for a maximum of about 10 seconds, preferably about 7 seconds, more preferably about 5 seconds.

As far as the delivery of the beverage is concerned, according to an aspect of the present invention, the at least one delivering assembly is activated manually thanks to a lever, or similar manual actuating means placed on, or connected to, the delivering assembly itself. According to an alternative embodiment, the actuation of the delivering assembly occurs automatically instead, thanks to the presence of a button, or other input devices known in the art.

In general, it should be noted that while stirring the beverage, the outlet section of the delivering assembly is closed to prevent the fluid generated by the source from flowing outside from the outlet of the dispenser, instead of being injected into the storage chamber.

The present invention further concerns a method of use of a device for containing and preserving beverages according to the present invention.

The method comprises the step of injecting a quantity of beverage into the storage chamber of the beverage containing device.

The method further comprises at least one step of stirring the beverage preserved inside the storage chamber of the device, by means of a fluid flow generated by at least one fluid source.

According to an aspect of the present invention, during the step of stirring the beverage preserved inside the storage chamber, the fluid source is in fluidic connection with the level gauge which, in turn, is in fluidic connection with the beverage storage chamber to channel the fluid flow generated by the fluid source into such storage chamber.

According to an aspect of the present invention, during the stirring step, the valve interposed between the fluid source and the gauge level, preferably with the opening of the first way of the valve, allows the fluidic connection of the fluid source with the level gauge.

According to an aspect of the present invention, the fluidic connection of the level gauge with the outer atmosphere is inhibited during the stirring step, preferably such control occurs by means of the valve interposed between the stirring fluid source and the level gauge.

In short, according to an aspect of the present invention, the step of opening one way of the valve placed between the fluid source and the level gauge occurs during the beverage stirring step to allow the passage of the stirring fluid coming from the fluid source, through the gauge, towards the storage chamber of the beverage containing device. Preferably, the flow passes through the lower part of the device.

In this step, the fluidic connection of the at least one level gauge with the outer atmosphere is preferably inhibited thanks to the closing of the relative way of the valve. This way, advantageously, the fluid flow coming from the fluid source can only run through one path, i.e. the one entering the storage chamber.

The method according to the invention further comprises the step of detecting the level of the beverage inside the storage chamber by means of a level gauge.

According to an aspect, during the step of detecting the level of the beverage inside the storage chamber, the level gauge is in fluidic connection with the outer atmosphere, preferably the second way of the valve placed between the level gauge and the fluid source is open to allow the fluidic connection of the level gauge with the outer atmosphere (P₀).

Advantageously, in this step, the way of the valve towards the fluid source is inhibited. It should also be noted that, while delivering the beverage through the delivering assembly, the fluidic connection of the level gauge with the fluid source is inhibited, for example by closing the appropriate way of the valve, so that to prevent the stirring the beverage during the delivery itself as well as the spillage of the beverage and the stirring fluid flow from the delivering assembly.

A possible embodiment according to the present invention comprises a plurality of containing devices and a fluid source for injecting stirring fluid into one or more storage chambers of said plurality of containing devices, at least one valve is arranged downstream of the fluid source and is connected to two or more devices.

Advantageously, the valve downstream of the fluid source is intended to channel the fluid flow coming from the source towards at least one of the two or more beverage containing devices. Advantageously, in this way, it is possible to select in which storage chamber(s) of the beverage containing device(s) to channel the fluid flow and thus stir the beverage.

A further object of the present invention is a machine for preparing beverages, and especially coffee, comprising at least one device for containing and preserving at least one beverage according to the invention and having at least one storage chamber for containing and preserving at least one beverage prepared in the machine.

According to an aspect of the present invention, the machine for preparing beverages comprises at least one chamber, preferably one percolation chamber, adapted to house at least one ingredient and to receive a flow of water for the formation of the beverage, and at least one beverage containing device, according to the present invention, provided with at least one storage chamber in which the beverage coming out of the chamber, in which at least one ingredient for preparing the beverage is housed, is collected.

According to an aspect, the water for preparing the beverage, and especially coffee, is warm water. The warm water is injected into the machine chamber in which the ingredient is housed.

As mentioned, according to an aspect of the present invention, the machine for preparing the beverage is a percolation machine.

The present invention further concerns a method of use of a machine according to the present invention.

The method comprises the step of preparing the beverage in the machine, preferably by injecting a quantity of water into the at least one chamber (for example a percolation chamber) of the machine for the passage through the ingredient for the preparation of the beverage, and the step of collecting the beverage prepared inside the at least one storage chamber of the beverage containing device.

The method further comprises the step of stirring the beverage contained inside the storage chamber of the containing device, by means of a stirring fluid flow generated by at least one fluid source.

Advantageously, it is possible to activate the stirring of the coffee at a preferred time or to set it in automatic mode at the end of a percolation cycle, or according to predetermined time intervals.

According to a possible embodiment, the machine according to the invention comprises a plurality of beverage containing devices according to the present invention and a fluid source to inject fluid into one or more storage chambers of said plurality of devices.

A further object of the present invention is the use of at least one fluid source, for example pressurized air, to stir the beverage. As mentioned, in this way, the beverage present inside the storage chamber of the beverage containing device is made uniform immediately following the step of preparing the beverage (for example by percolation), or successively for example to a given period of permanence of the beverage inside the storage chamber.

### BRIEF DESCRIPTION OF THE DRAWINGS

These and other advantages of the present invention will become clearer in the following description and accompanying drawings, provided by way of example and without limitations, in which:

FIGS. 1 and 1A are respectively a partial sectional view and a schematic view of a possible embodiment of a beverage containing device according to the invention;

FIG. 2 schematically shows a possible embodiment of the machine for preparing the beverage, by percolation, according to the invention in which there is a percolation chamber and a corresponding beverage containing device according to the invention;

FIG. 3 schematically shows a further possible alternative embodiment of the machine for preparing the beverage, by percolation, according to the invention in which there are two percolation chambers and two corresponding beverage containing devices;

FIG. 4 is a perspective view of a possible embodiment of the machine for preparing the beverage by percolation, according to the invention, in which there are two percolation chambers and two corresponding beverage containing devices according to the invention;

FIG. 5 is a partial view in section of the machine in FIG. 4, in which the fluidic connection of the storage chamber of the beverage containing device with the level gauge and the delivering assembly is shown.

### METHOD FOR IMPLEMENTING THE INVENTION

With reference to the accompanying figures, some possible embodiments of the device 5 for containing and preserving a beverage, as well as the machine 1 for preparing the beverage, will now be described, starting from the initial injection of the beverage into the storage chamber 5a of the containing device 5.

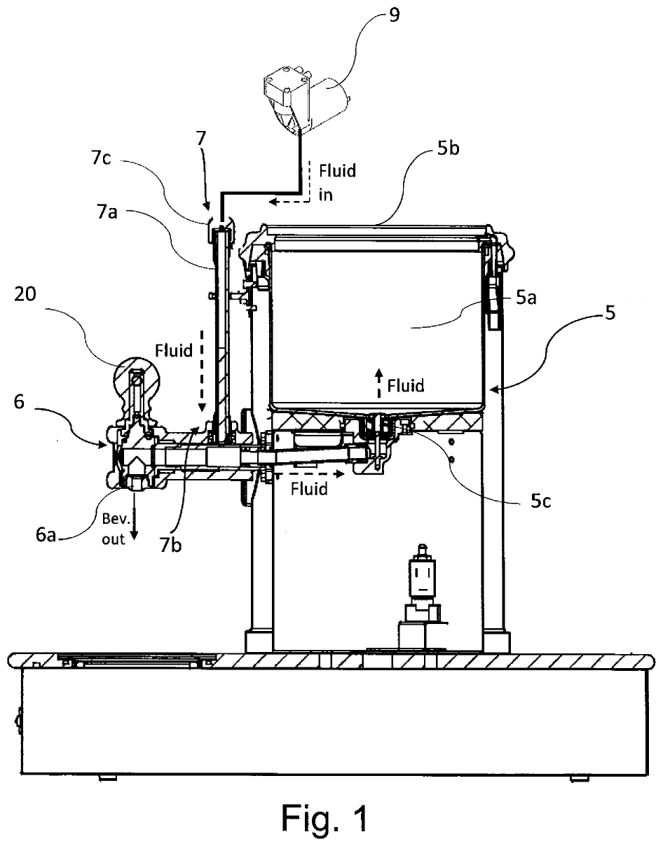

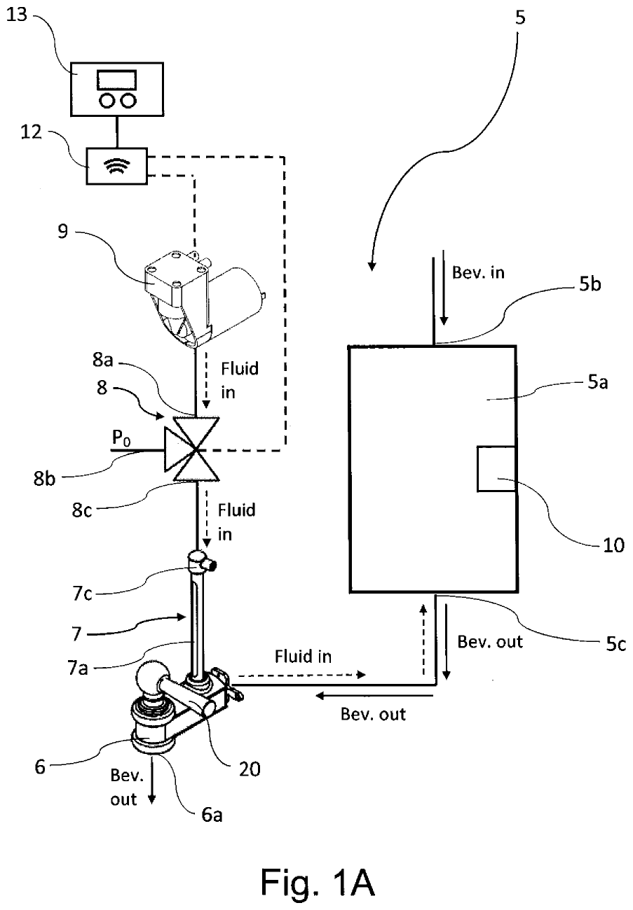

As for example shown in FIG. 1, the device 5 comprises a beverage storage chamber 5a, which according to a possible embodiment occupies the volume defined by the upper section of such device 5. Such storage chamber 5a is provided with at least one inlet 5b for injecting the beverage and with at least one outlet 5c, wherein the outlet 5c is fluidically connected with a delivering assembly 6 which allows to deliver the beverage through an outlet section 6a towards an outer container of the user, such as for example a cup, a glass or other container (not shown in the accompanying figures).

The device 5 comprises at least one fluid source 9 (for example schematically shown in FIG. 1), preferably air, for the adduction of a fluid flow into said storage chamber 5a which determines the stirring of the beverage.

The term chamber is here used to denote a volume defined by walls inside which it is possible to contain a liquid, for example the chamber can comprise, or be constituted by, a container or tank, both of the fixed type and the type removable from the device 5 and from the machine 1. The chamber can have one or more inlets for the beverage and, in general, for a liquid and one or more outlets for the beverage and, in general, for a liquid. In the embodiment shown in the figures, the beverage containing device 5 has cylindrical shape, however other shapes can obviously be used.

The inlet 5b of the storage chamber is preferably arranged above and the outlet 5c is preferably arranged below, the latter being preferably positioned on the lower wall of such storage chamber 5a. According to a possible embodiment, the outlet has dimensions smaller than the inlet.

The outlet 5c is preferably arranged on the bottom wall of the storage chamber 5a of the device 5 and, according to a possible embodiment, it is fluidically connected to a delivering assembly 6 and, as will be seen, according to a possible embodiment, to a level gauge 7.

The inlet 5b allows to collect a beverage, for example a beverage prepared in a machine 1 whenever the device 5 is used in a machine 1 for preparing a beverage.

According to a preferred embodiment, the beverage enters the storage chamber 5a by gravity.

It should be noted that the components of the device 5 are in fluidic connection between one another, in other words, the beverage or stirring fluid is channeled among the various components of the device 5 by means of suitable ducts, or similar fluidic channeling means of the known art.

In other words, the expressions “fluidic connection” or “fluidically connected” are herein used to denote that a component of the beverage containing device is connected to another component thereof to allow the transfer of fluid between them, i.e. allowing the fluidic communication.

In the accompanying figures, the fluidic connection between the components of the device is schematically illustrated by means of lines and arrows denoting the running direction of the beverage or fluid.

It should also be noted that the terms “downstream,” “upstream” are used to denote the position of a component of the device with respect to another, with reference to the running direction of the fluid inside the device itself.

According to a possible embodiment, as known, the beverage is injected into the storage chamber 5a of the device 5, to which is in turn connected a delivering assembly 6, thanks to which the beverage is provided to the user.

According to an aspect of the present invention, the delivering assembly 6 comprises a lever 20 which allows the user to manually actuate the delivery of the beverage. In alternative, buttons or other input means known in the art allow an actuation of the manual or automatic type, or of a combination thereof, of the delivering assembly 6.

In a possible embodiment, the device 5 comprises means 10 to control the temperature and which allow to maintain or change the temperature of the beverage injected into the storage chamber 5a. Such means are of the known type and comprise, for example, one or more resistances or similar heating devices.

According to a possible embodiment, the device 5 further comprises a level gauge 7 which is intended to detect and show, to the user, the level of the beverage present inside the storage chamber 5a of the device 5 itself.

Level gauges, also known in the art as level indicators, are known in the art and allow to measure a liquid inside a container, or bowl, or tank. In the present invention, the level gauge is used to show the level (and thus the volume) of beverage present inside the storage chamber 5a.

Generally, the level gauge 7 is a tool that is able to measure the height of the free surface of the liquid contained inside the storage chamber, with respect to a plane of reference, preferably with respect to the lower wall of the storage chamber 5a of the device 5 (and in general of the container housing the liquid to be measured).

As known, the level gauges 7 can use different physical principles to measure the liquid, such as for example the principle of communicating vessels, the Archimedes' principle or the hydrostatic pressure principle.

Preferably, in the beverage containing device 5, level gauges also known as pipe level indicators, or glass-pipe level indicators, which preferably exploit the principle of communicating vessels, are used.

In detail, according to a possible embodiment, the level gauge 7 comprises a display pipe 7a, preferably transparent (and generally made of glass) having a first end 7b fluidically connected with said storage chamber 5a of said beverage containing device 5.

The pipe 7a is fluidically connected with the storage chamber 5a so that part of the beverage flows in the display pipe 7a and, depending on the level present inside the storage chamber 5a, assumes a height inside the display pipe such as to denote the height of the free surface of the beverage inside the storage chamber 5a.

According to a possible embodiment, the level gauge 7 is connected to the outlet duct of the storage chamber 5a which is in turn connected to the outlet 5b of such storage chamber 5a.

According to a possible embodiment, such as for example shown in the accompanying figures, the level gauge 7 is combined with the delivering assembly 6.

More in detail, according to a possible embodiment, the level gauge 7, and in particular the display pipe 7a, constitutes a branch of the outlet duct of the beverage from the storage chamber 5a towards the delivering assembly 6. According to a possible embodiment, the delivering assembly 6 comprises a branch, preferably T-shaped, at which the display pipe 7a of the level gauge 7 is placed.

According to a possible embodiment, the gauge 7 is connected to the outer environment and thus with the outer atmosphere (schematically denoted by P₀), preferably at its upper end 7c.

More in detail, the second end 7c of the display pipe 7a is in fluidic connection with the outer environment (atmospheric pressure) so that to allow the part of the beverage coming out of the storage chamber 5a to arrange itself inside the pipe 7a at a certain height, which depends on the height of the free surface of the beverage inside the storage chamber 5a.

According to an aspect of the invention, the level gauge 7 is connected to a fluid source 9. However, possible embodiments in which the fluid source 9 adapted to stir the beverage is in fluidic connection with the storage chamber 5a by means of a connecting opening or section, for example a hole or opening arranged on one of the walls delimiting the storage chamber, are not to be excluded, or possible embodiments in which the fluid source 9 for stirring the beverage is in fluidic connection with the inlet or the outlet of the storage chamber 5a are not excluded.

According to the possible embodiment in which the level gauge 7 is connected to the fluid source 9, the connection preferably occurs by means of the second opening 7c, generally the upper opening 7c, of the display pipe 7a.

As mentioned, such fluid source 9, preferably pressurized air or compressed air, is of the type known in the art and comprises for example a pump or a compressor, preferably a compressor supplied by direct current. However, possible embodiments in which the fluid source comprises a tank or container in which the fluid injected into the storage chamber is housed to stir the beverage contained therein should not be excluded.

According to an aspect of the present invention, the level gauge 7 is alternatively fluidically connected with the fluid source 9 (when needing to stir the beverage contained inside the storage chamber 5a), or with the outer environment and thus with the atmospheric pressure P₀ (when needing to measure the level of the beverage inside the storage chamber 5a).

The selective fluidic connection of the level gauge 7, and in particular of the upper end 7c of the display pipe 7a, with the atmospheric pressure P₀ or with the fluid source 9 can be regulated. Preferably, according to an aspect of the invention, means that are able to selectively connect the opening 7c with the fluid source 9 or with the outer environment (atmospheric pressure P₀) are provided.

According to a possible embodiment, a valve 8, preferably a three-way valve, is arranged between the fluid source 9 and the level gauge 7.

The valve 8 is of known type and can be preferably actuated electrically, for example the valve is of the solenoid type.

As mentioned, according to an embodiment, the valve 8 alternatively connects the level gauge 7 fluidically with the atmosphere P₀ or with a fluid source 9.

More in detail, the three-way valve 8 comprises a first way 8a fluidically connected with the fluid source 9, a second way 8b fluidically connected with the outer atmosphere (P₀) and a third way 8c fluidically connected with the level gauge 7, preferably connected with the end 7c of the display pipe 7a.

It should be noted that the connection of the valve 8 with the components mentioned above and with the outer environment can occur by known means, for example by means of appropriate connecting ducts.

Moreover, the term “way” denotes, as known, the passage sections or openings the valve body is provided with and which are in fluidic connection between each other and can be selectively opened/closed by known means, such as for example mobile shutters, for example of the spherical or needle type, etc.

When the level of the beverage inside the storage chamber 5a is detected, the valve 8 connects the gauge 7 fluidically with the atmospheric pressure and thus inhibits the direct connection with the fluid source 9.

Instead, the fluid source 9 allows to channel the fluid adapted for the stirring, by means of the valve 8 and the level gauge 7, into the storage chamber 5a, preferably through the lower wall of the storage chamber 5a of the device 5. The beverage placed inside the storage chamber 5a is stirred by means of this fluid flow. In other words, the fluid flow injected into the storage chamber 5a thus determines the beverage stirring effectiveness, avoiding the drawbacks reported in the devices, as well as in the machines, known for the stratification/sedimentation of the beverage.

In particular, by means of a control unit 12 connected to the valve 8 and to the pressurized fluid source 9 and to a control panel 13, it is possible to activate the fluid flow to stir the beverage. I.e., the fluid source 9 is activated and the valve 8 is opened to allow the passage of fluid from the source 9 itself to the level gauge 7 and, through it, to the storage chamber 5a.

The control panel 13 is of a known type, for example a touchscreen panel, physical buttons, etc.

Thus, according to an aspect of the present invention, the device 5 is able to carry out the beverage delivering operation with the usual detection of the level of the beverage inside the storage chamber 5a, and is also able to stir the beverage inside the storage chamber 5a when necessary (for example when desired by the user) or automatically according to predetermined time intervals.

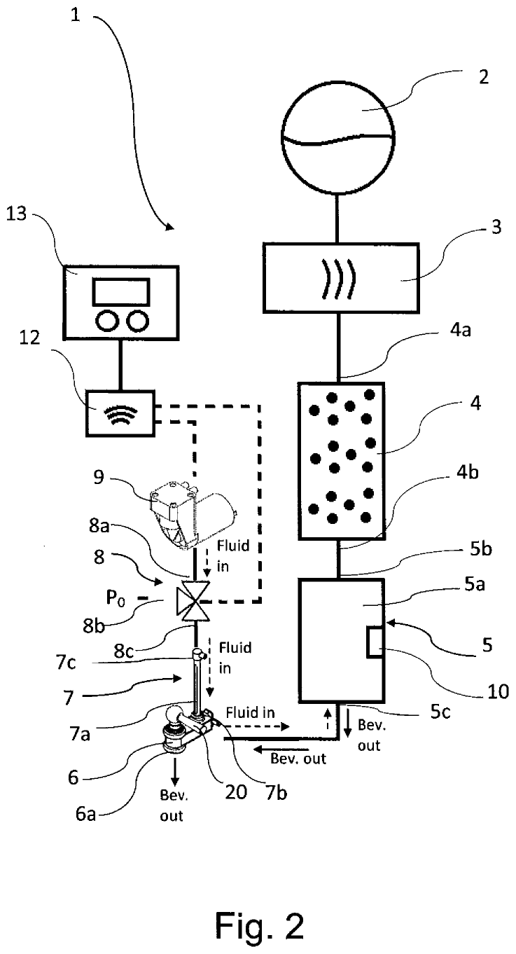

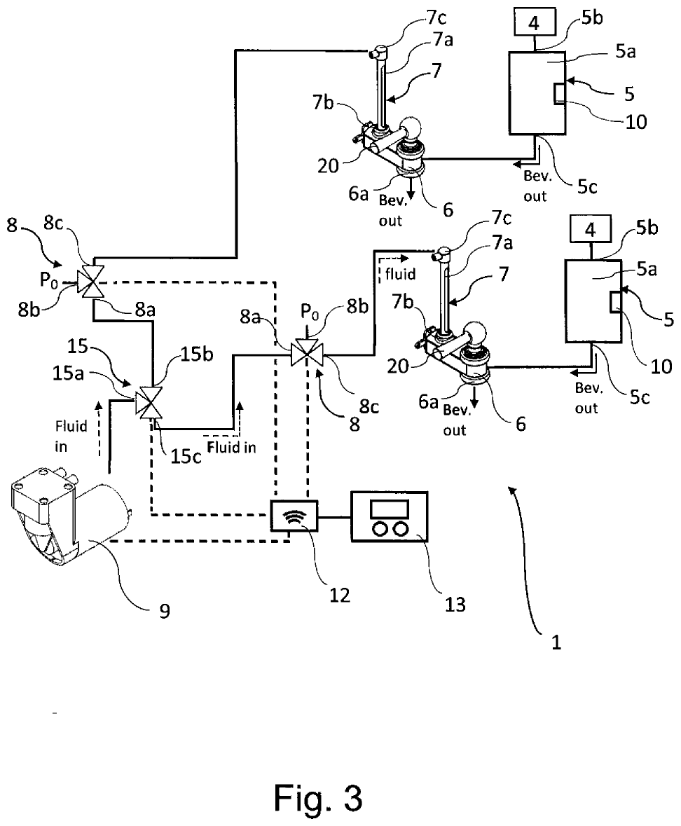

During the normal operation of the containing device 5, during the beverage delivering operation with the indication of the level of the beverage preserved inside the storage chamber 5a through the level gauge 7, the beverage follows the path denoted by the continuous arrows (shown for example in FIGS. 2 and 3), thus passing from the storage chamber 5a contained in the device 5 through an appropriate duct, towards the delivering assembly 6.

The level gauge 7 is in fluidic connection with the outer environment so that to be able to ensure the level of the beverage inside the storage chamber 5a to be displayed.

More in detail, according to a possible embodiment, the second way 8b of the valve 8 is open and allows the fluidic connection of the level gauge 7, and in particular of the opening 7c, with the outer atmosphere P₀. At the same time, the first way 8a of the valve 8 is closed so that to inhibit the fluidic connection with the fluid source 9.

Instead, while stirring the beverage, once the control unit 12 is activated to operate the fluid source 9 and to appropriately regulate the valve 8, thanks to the action of an operator through the control panel 13, the fluid flow follows the path denoted by the dotted arrows (shown for example in FIGS. 2 and 3).

More in detail, the second way 8b of the valve is closed so that to inhibit the fluidic connection with the outer environment P₀. The first way 8a is open to allow the fluid flow generated by the source 9 to reach the level gauge 7 and thus the storage chamber 5a. Obviously, the third way 8c of the valve 8 is open to allow the passage of the fluid flow towards the level gauge 7.

Consequently, once the fluid flow is generated by the source 9, it crosses the valve 8 to be injected into the storage chamber 5a. Therefore, it is possible to activate the stirring of the beverage at a preferred time or to set it in automatic mode, according to predetermined time intervals, through the control panel 13. The beverage stirring step can also advantageously be preset.

As mentioned, a further embodiment in which there are two containing devices 5 connected to a respective dispenser 6, and each provided with a level gauge 7, is shown in FIG. 3.

These gauges 7 detect the quantity of beverage present inside the storage chamber 5a. Obviously, according to further possible embodiments, the number of devices 5 can be increased depending on the needs.

According to an aspect of the present invention, such delivering assemblies 6 comprise levers 20 thanks to which the user activates the delivery of the beverage of the single assembly towards the outside.

The fluid generated by a shared source 9 can thus be directed towards the respective storage chamber 5a of one or more of the containing devices 5, or can be channeled selectively towards a given storage chamber 5a of a given device 5, through a valve 15 or similar sorting means of the fluid flow.

This way, different devices 5 can be connected to a fluid source 9, thus determining a saving in terms of the components necessary for the operation.

The valve 15 is of the known type and can be actuated electrically. The valve is preferably of the three-way type and can be actuated electrically, such as for example a solenoid valve.

A first way 15a of the valve 15 is connected to the fluid source 9, a second way 15b is connected to the duct transporting the fluid towards a first storage chamber 5a of a first containing device 5, whereas the third way 15c is connected to the duct transporting the fluid towards a second storage chamber 5a of a second containing device 5.

More in detail, according to a possible embodiment, the second way and the third way 15b, 15c are respectively connected with the valves 8 which, as described previously, are arranged upstream of the level gauge 7 and allow to fluidically connect, selectively, the level gauge 7 with the fluid flow coming from the source 9, or with the outer environment and thus with the atmospheric pressure P₀.

More in detail, as for example shown in the schematic view of FIG. 3, each level gauge 7 is connected with the outer atmosphere (denoted by P₀) by means of a valve 8, preferably of the three-way type. Such valve 8 is further connected, through the interposition of the valve 15, to at least one fluid source 9.

As already mentioned, for example with reference to the embodiment shown in FIG. 2, during the delivery of the beverage through the delivering assembly 6, the valve 8 allows the fluidic connection of the level gauge 7 with the outer environment and thus with the atmospheric pressure P₀, and allows the user to detect the content of the beverage inside the storage chamber 5a through the level gauge 7.

When needing to stir the beverage inside the storage chamber 5a, the valve 15 has the task of deviating the stirring fluid flow generated by the source 9 towards at least one valve 8 and thus towards the level gauge 7 and the storage chamber 5a.

For example, the control unit 12, activated by the user by means of the control panel 13 allows to regulate the operation of the at least one fluid source 9, the valves 8 and the valve 15.

The user, by means of the control panel 13 and the control unit 12, activates the operations of the fluid source 9 and selects the at least one device 5 to stir the beverage in at least one storage chamber 5a. This way, the valve 8 is controlled so that to allow the passage of the fluid flow coming from the fluid source 9 towards the at least one level gauge 7 and at least one storage chamber 5a, in which the stirring of the beverage occurs. Advantageously, during this process, the at least one valve 8 inhibits the fluidic connection of the beverage inside the level gauge 7 with the outer environment P₀. In other words, during the stirring of the beverage, the second way 8b of the valve 8 is closed, preventing the connection with the outer atmosphere P₀.

According to possible embodiments, the stirring of the coffee inside the storage chamber 5a, by means of the entering flow fluid coming from the fluid source 9, lasts for more than 1 second, preferably more than 3 seconds. According to possible embodiments, the stirring cycle lasts for a maximum of about 10 seconds, preferably about 7 seconds, more preferably about 5 seconds.

Still with reference to the accompanying figures, some possible embodiments of the machine 1 according to the present invention, for preparing a beverage, will now be described. Also if particular reference will be made to the preparing of the beverage by percolation hereinafter, other methods of preparing the beverage starting from one or more ingredients are not to be excluded.

Specifically, reference will be made to the preparing of brewed coffee by percolation starting from ground powdered coffee, however other uses of the machine 1 for preparing other beverages are not to be excluded.

It should also initially be noted that what is here described and/or claimed with reference to the device 5 and to the relative method of use, can be applied to the machine 1, and vice-versa.

The machine 1 according to the present invention, such as for example shown in FIG. 2, comprises a water source 2, a boiler 3, a percolation chamber 4, a device for containing and preserving beverages 5 according to the present invention, to collect the percolated beverage before its delivery, which occurs through a delivering assembly 6. The percolation chamber 4 is provided, as known, with an inlet 4a to enter coffee powder, or other ingredient. The beverage extraction water is injected into the percolation chamber 4 through an opening which can be at, or separate from, the inlet 4a intended for the entering of the coffee powder.

The percolation chamber 4 is further provided with at least one outlet 4b, preferably lower and arranged at the bottom of the chamber, for the coming out of the beverage. As known, the percolation chamber 4 is provided with filtering means known in the art and not shown in the accompanying figures. The filtering means can be fixed or removable.

According to a preferred embodiment, the beverage enters the storage chamber 5a of the containing device 5 by gravity, the device 5 being arranged underneath the percolation chamber 4.

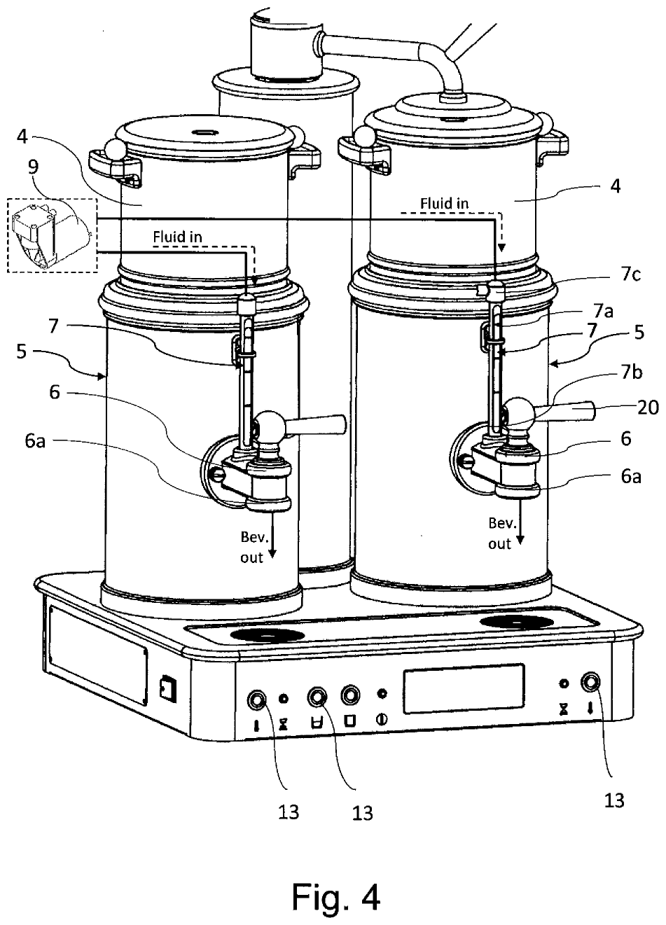

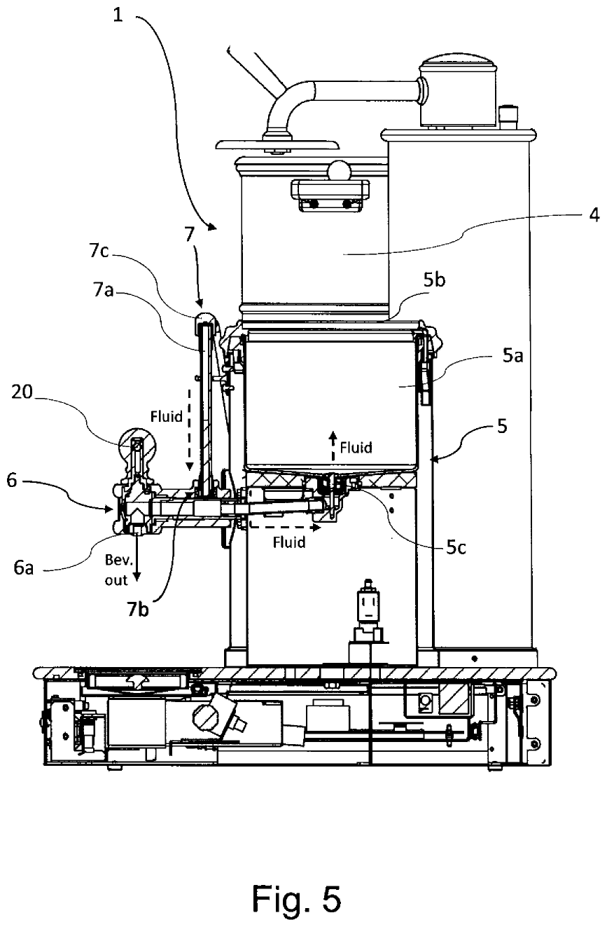

It should be noted that in the possible embodiment schematically depicted in FIG. 2, the machine 1 is provided with only one percolation chamber 4 and with a corresponding device for containing and preserving beverages 5, whereas in the possible embodiments for example schematically depicted in FIGS. 3-4, the machine comprises two percolation chambers 4 and two corresponding devices 5. Obviously, the same components in the embodiments shown are denoted by the same numerical references.

As mentioned, FIG. 3 shows a further embodiment of the machine, in which there are two devices 5 according to the present invention, each provided with a level gauge 7 and each connected to a respective delivering assembly 6.

Obviously, according to further possible embodiments, the number of devices 5 can be increased depending on the needs.

It should also be noted that the components of the machine 1 are in fluidic connection with each other, in other words, the water or fluid are transported between the various components of the machine 1 by means of appropriate ducts, or similar fluidic transport means known in the art.

In other words, the expressions “fluidic connection” or fluidically connected” are herein used to denote that a component of the machine is connected to another component of the machine to allow the transfer of fluid between them.

In the accompanying figures, the fluidic connection between the components of the machine is schematically depicted by means of lines and arrows denoting the running direction of the fluid.

It should also be noted that the terms “downstream,” “upstream” are used to denote the position of a component of the machine with respect to another, with reference to the running direction of the fluid inside the machine itself.

According to a possible embodiment, as known, in the machine 1, the water coming from a source 2 is connected, generally by a duct, to a boiler 3. Here, through the heating means known in the art, the water temperature rises towards values preferably lower than the boiling ones.

The water heated this way, through an appropriate duct reaches the percolation chamber 4 which is previously supplied by the user with ground coffee (or other ingredient) having the desired granulometry.

The percolation time depends on various factors, among which the granulometry of the powdered ingredient. By exploiting the effect of the force of gravity, the water permeates through the percolation chamber 4 and thus through the powdered coffee contained therein, and extracts its aromas, oils, etc. The beverage obtained is channeled towards a device 5 for containing and preserving the beverage according to the present invention, which is in fluidic connection with a delivering assembly 6, through which the beverage is supplied to the user.

Thus, according to an aspect of the present invention, the machine 1 is able to carry out the beverage delivering operation with the usual detection of the level of the beverage inside the storage chamber 5a, and is also able to stir the beverage inside the storage chamber 5a when necessary (for example when desired by the user) or automatically at the end of each percolation cycle, or according to predetermined time intervals.

During the normal operation of the machine for delivering the beverage with the indication of the level of the beverage preserved inside the storage chamber 5a through the level gauge 7, the beverage follows the path denoted by the continuous arrows (shown for example in FIGS. 2 and 3), thus passing from the storage chamber 5a through an appropriate duct, towards the delivering assembly 6.

What described above with reference to the containing device 5, and in particular with reference to the steps of stirring the beverage, is applied equally to the machine 1 according to the invention as well as to its method of use.

1. Device (5) for containing and preserving beverages, comprising at least one storage chamber (5a) for at least one beverage, said storage chamber (5a) being provided with at least one inlet (5b) for the injection of the beverage and with at least one outlet (5c), wherein the outlet (5c) is fluidically connected to a delivering assembly (6) for the delivery of the beverage, said device (5) being characterized in that it comprises at least one fluid source (9) fluidically connected with said at least one storage chamber (5a) for the adduction of a fluid flow into said storage chamber (5a) to stir said beverage.

2. Device (5) according to claim 1, characterized in that said at least one fluid source (9) is a pressurized fluid flow.

3. Device according to claim 1 or 2, wherein said fluid is air, or a gas or a liquid, or a beverage being the same or different from the one contained in the storage chamber, or part of the beverage which is in the storage chamber and drawn from the storage chamber and released back into the storage chamber, or a combination thereof.

4. Device (5) according to any one of the preceding claims, characterized by comprising at least one level gauge (7) of the beverage contained in said at least one storage chamber (5a).

5. Device (5) according to claim 4, wherein said at least one level gauge (7) is fluidically connected with said storage chamber (5a) and with said at least one fluid source (9), preferably said level gauge (7) being placed between said at least one fluid source (9) and said at least one storage chamber (5a) of said containing device (5).

6. Device (5) according to claim 5, wherein the fluid delivered from said at least one fluid source (9) passes through said level gauge (7) in order to reach said at least one storage chamber (5a).

7. Device (5) according to any one of the preceding claims, characterized by comprising controlling means (10) to control the temperature, which are adapted to maintain or change the beverage temperature.

8. Device (5) according to any one of preceding claims 4 to 7, wherein at least one valve (8) is placed between said at least one fluid source (9) and said at least one level gauge (7).

9. Device (5) according to any one of preceding claims 4 to 8, wherein said at least one level gauge (7) is further fluidically connected with the outer atmosphere (P₀), preferably by said at least one valve (8) placed between said at least one fluid source (9) and said at least one level gauge (7).

10. Device (5) according to claim 8 or 9, wherein said at least one valve (8) is of the three-way type, the first way (8a) being fluidically connected with the fluid source (9), the second way (8b) being fluidically connected with the outer atmosphere (P₀) and the third way (8c) being fluidically connected with the level gauge (7).

11. Device (5) according to any one of preceding claims 4 to 10, wherein said at least one level gauge (7) comprises a display pipe (7a), preferably transparent, having a first end (7b) fluidically connected with said storage chamber (5a).

12. Device (5) according to claim 11, wherein said display pipe (7a) comprises a second end (7c) fluidically connected with said fluid source (9).

13. Method of use of at least one device (5) for containing and preserving beverages according to any one of claims 1 to 12, the method comprising the step of injecting at least one beverage into at least one storage chamber (5a) of the at least one device (5), the method being characterized by comprising at least one step of stirring said beverage contained in said at least one storage chamber (5a) by a fluid flow generated by said at least one fluid source (9).

14. Method according to claim 13, wherein during said step of stirring the beverage contained in said at least one storage chamber (5a) of said at least one device (5), the at least one fluid source (9) is fluidically connected with the at least one level gauge (7), the latter being in turn fluidically connected with the storage chamber (5a) to direct the fluid flow generated by the source (9) into said storage chamber (5a).

15. Method according to claim 13 or 14, wherein said step of stirring the beverage contained in said at least one storage chamber (5a) comprises the opening of the first way (8a) of said at least one valve (8) for the fluidic connection of said at least one fluid source (9) with said at least one level gauge (7), in order to direct the fluid flow generated by the source (9) towards the storage chamber (5a).

16. Method according to any one of claims 13 to 15, wherein in said step of stirring the beverage contained in said at least one storage chamber (5a), the fluidic connection of said level gauge (7) with the outer atmosphere (P₀) is inhibited, preferably the second way (8b) of said at least one valve (8) is closed to inhibit the fluidic connection of said at least one level gauge (7) with the outer atmosphere (P₀).

17. Method according to any one of claims 13 to 16, wherein the step of stirring the beverage contained in said at least one storage chamber (5a) lasts more than 1 second, preferably more than 3 seconds and/or wherein the stirring step lasts for a maximum of about 10 seconds, preferably about 7 seconds, more preferably about 5 seconds.

18. Method according to any one of claims 13 to 17, characterized in that the step of stirring the beverage inside the storage chamber (5a) is manually operated or automatically operated by a control unit (12).

19. Method according to any one of claims 13 to 18, characterized by comprising the step of detecting the level of said beverage in the storage chamber (5a) of the device (5) by said at least one level gauge (7).

20. Method according to claim 19, wherein in said step of detecting the level of said beverage in the storage chamber (5a), said level gauge (7) is fluidically connected with the outer atmosphere (P₀), preferably the second way (8b) of said at least one valve (8) is open to allow the fluidic connection of said at least one level gauge (7) with the outer atmosphere (P₀).

21. Method according to any one of claims 13 to 20, comprising the step of injecting fluid into at least one storage chamber (5a) of one or more beverage containing devices of a plurality of beverage containing devices (5), preferably said step comprising the activation of at least one valve (15) arranged downstream of said fluid source (9) and connected to two or more beverage containing devices (5).

22. Machine (1) for preparing a beverage, especially coffee, comprising at least one device (5) according to any one of claims 1 to 12 having at least one storage chamber (5a) for containing and preserving at least one beverage prepared in said machine.

23. Machine for preparing a beverage, especially coffee, according to claim 22, comprising at least one chamber (4), preferably a percolation chamber, adapted to house at least one ingredient and to receive a water flow for making the beverage, said beverage exiting from said chamber (4) being collected in said at least one storage chamber (5a) of said device (5).

24. Machine for preparing a beverage, and especially coffee, according to claim 23, wherein the water for making the beverage, and especially coffee, is warm water.

25. Method of use of a machine (1) according to any one of claims 22-24, the method comprising the step of preparing said beverage in said machine and collecting the beverage prepared in said at least one storage chamber (5a) of said device (5), the method being characterized in that it comprises at least one step of stirring said beverage contained in said storage chamber (5a) of said at least one beverage containing device (5) by a fluid flow generated by said at least one fluid source (9).

26. Method of use of a machine (1) according to any one of claims 22 to 25, characterized by comprising one or more steps according to any one of claims 13 to 21.

27. Use of at least one fluid source (9) for stirring the beverage, preferably coffee, contained in at least one storage chamber (5a) of at least one device (5) for containing beverages.
